(19) United States
(12) Patent Application Publication
(10) Pub. No.: US 2012/0320569 A1
(43) Pub. Date: Dec. 20, 2012

(54) WARNING LAMP ASSEMBLY FOR SAFETY HELMET

(75) Inventor: Wen-Chi LU, Taipei City (TW)

(73) Assignee: TAI-SOL ELECTRONICS CO., LTD.

(21) Appl. No.: 13/212,518

(22) Filed: Aug. 18, 2011

(30) Foreign Application Priority Data
Jun. 20, 2011 (TW) 100211149

(51) Int. Cl. F21V 21/084

(52) U.S. Cl. 362/106

(57) ABSTRACT

A warning lamp assembly for use in a safety helmet is disclosed to include a watertight housing having a part thereof transparent, a circuit board mounted inside the housing and carrying a control circuit, a direction and speed sensor and a warning lamp set that are electrically connected together, a battery pack mounted inside the housing and electrically connected to the circuit board to provide battery power to the components at the circuit board, and a mounting device located on the outside of the housing and detachably connectable to a safety helmet. Thus, the warning lamp assembly has the characteristics of simple structure and ease of installation and is detachably connectable to a safety helmet.

### BACKGROUND OF THE INVENTION

1. Field of the Invention

The present invention relates to safety helmet technology and more particularly, to a warning lamp assembly for use on a safety helmet.

2. Description of the Related Art

Many warning lamp products for use on a safety helmet have been created. However, these warning lamp products commonly have a complicated structure and require an operating procedure, not convenient for use. For example, Taiwan Utility M293687 discloses a_warning lamp for safety helmet, entitled “Safety Helmet Third Stop Light Structure”, which teaches the use of a wireless interface for transmitting the user's instruction to a stop light at a safety helmet, driving the stop light to emit light. However, this structure must be coupled to an operating button of a motorcycle that controls the operation of the motorcycle's directional lights and stop light so that the user's instruction can be effectively transmitted through the wireless interface. Further, installation of this structure is complicated, and may have to be done by a professional technician.

Taiwan Utility M366914 discloses another design of warning lamp for safety helmet, entitled “Active-warning safety helmet”, which teaches the use of a dynamic trigger device for dynamic triggering of a motion to control the light emitting status of a directional light unit and a stop light unit. However, the directional light unit and the stop light unit are installed in the helmet during the fabrication of the helmet and not detachable. A user already having a safety helmet must purchase a new active-warning safety helmet if he (she) wants this dynamic triggering function. It is not economic to put an old safety helmet away and then to purchase a new safety helmet.

### SUMMARY OF THE INVENTION

The present invention has been accomplished under the circumstances in view. It is the main object of the present invention to provide a warning lamp assembly for safety helmet, which has the characteristics of simple structure and ease of installation, and can be installed in a safety helmet in a detachable manner.

To achieve this and other objects of the present invention, a warning lamp assembly for safety helmet includes a watertight housing having a part thereof transparent, a circuit board mounted inside the housing and carrying a control circuit, a direction and speed sensor and a warning lamp set that are electrically connected together, a battery pack mounted inside the housing and electrically connected to the circuit board to provide battery power to the components at the circuit board, and a mounting device located on the outside of the housing and detachably connectable to a safety helmet. Thus, the warning lamp assembly has the characteristics of simple structure and ease of installation and is detachably connectable to a safety helmet.

### BRIEF DESCRIPTION OF THE DRAWINGS

FIG. 1 is a front view of a warning lamp assembly for safety helmet in accordance with a first embodiment of the present invention.

FIG. 2 is an exploded view of the warning lamp assembly for safety helmet in accordance with the first embodiment of the present invention.

FIG. 3 is a sectional view taken along line 3-3 of FIG. 1.

FIG. 4 is an applied view of the present invention, illustrating the warning lamp assembly installed in a safety helmet.

FIG. 5 is an oblique rear elevational and exploded view of a warning lamp assembly in accordance with a second embodiment of the present invention.

FIG. 6 is an exploded view of the warning lamp assembly for safety helmet in accordance with the second embodiment of the present invention.

### DETAILED DESCRIPTION OF THE INVENTION

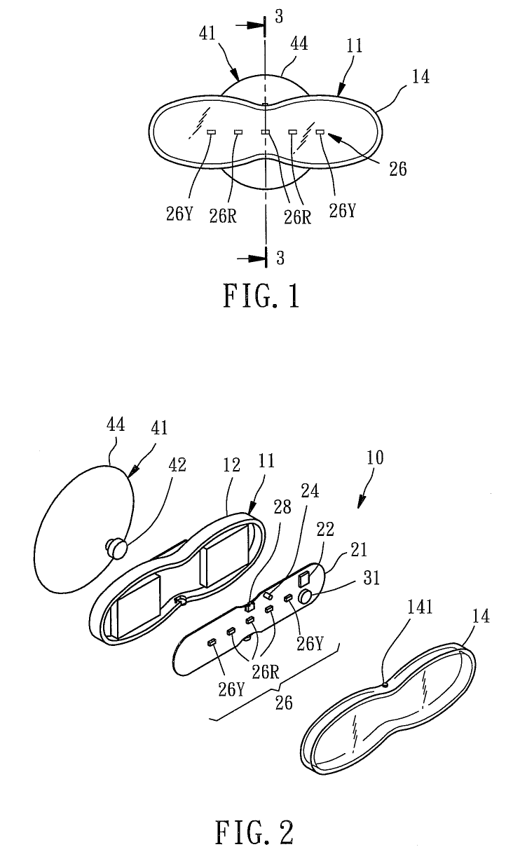

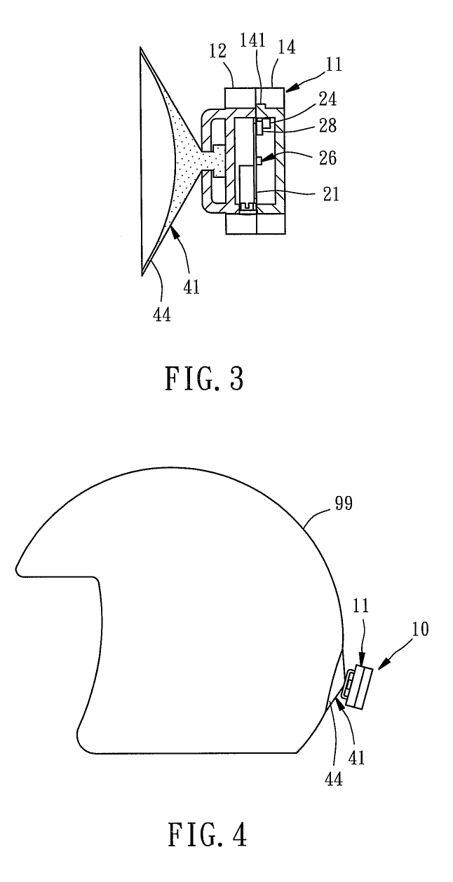

Referring to FIGS. 1-4, a warning lamp assembly 10 for use in a safety helmet in accordance with a first embodiment of the present invention is shown comprising a housing 11, a circuit board 21, a battery pack 31, and a mounting device 41.

The housing 11 consists of a body shell 12 and a cover shell 14. The cover shell 14 is transparent. The body shell 12 and the cover shell 14 are attached together and peripherally sealed to prevent permeation of water into the inside of the housing 11. According to this embodiment, the body shell 12 and the cover shell 14 are bonded together by high-frequency sealing technology. Thus, the body shell 12 and the cover shell 14 are seamlessly sealed, keeping the housing 11 in a watertight status.

The circuit board 21 is mounted inside the housing 11, comprising a control circuit 22, a direction and speed sensor 24 and a warning lamp set 26. The control circuit 22, the direction and speed sensor 24 and the warning lamp set 26 are electrically coupled together. According to this embodiment, the direction and speed sensor 24 is capable of sensing the variation in the directions of X, Y, Z direction axes and gravitational acceleration. Further, in this embodiment, the warning lamp set 26 consists of a plurality of light-emitting diodes, i.e., 5 LEDs transversely arranged in a row, wherein the left and right LEDs 26Y are yellow LEDs, and the three LEDs 26R on the middle are red LEDs.

The battery pack 31 is mounted inside the housing 11 and electrically connected to the circuit board 21 to provide battery power supply to the components at the circuit board 21. The battery pack 31 can be a dry battery or rechargeable battery. According to this embodiment, the battery pack 31 is a rechargeable battery. When charging the battery pack 31, induction charging or wired charging may be adopted. The technique of induction charging is seen in induction charging type electric toothbrushes from Koninklijke Philips Electronics N.V. (Royal Philips Electronics). The technique of wired charging is commonly seen in regular cell phone and electronic products. As the connection interfaces of induction coil for induction charging and charging wire for wired charging are the known art, no further detailed description with related illustrations are necessary.

The mounting device 41 is mounted on the outside of the housing 11 for detachably fastening to a safety helmet 99. According to this embodiment, the mounding device 41 is a vacuum mount having a head 42 and a vacuum-forming cup 44. The head 42 is affixed to the housing 11.

The warning lamp assembly 10 of this first embodiment further comprises a switch 28 mounted in the housing 11 and electrically connected to the circuit board 21, as illustrated in FIG. 2, for switching by a user to turn on/off the battery pack 31. It is to be understood that the switch 28 is not a requisite component but simply to enhance user's operating convenience. If the switch 28 is omitted, the warning lamp assembly 10 keeps working before the battery pack 31 is unable to deliver its power. The switch 28 illustrated in FIG. 2 is to be triggered by a press block 141. When the user presses the press block 141, the switch 28 is triggered to produce an operating action.

After understanding of the structural details, the installation and operation of the warning lamp assembly 10 are outlined hereinafter.

Referring to FIG. 4, during installation, attach the rear side of the safety helmet 99 to have the warning lamp assembly 10 be secured to the safety helmet 99 by a vacuum suction force. When going to detach the warning lamp assembly 10 from the safety helmet 99, directly pull the vacuum-forming cup 44 away from the safety helmet 99.

After installation of the warning lamp assembly 10 in the safety helmet 99, the user can operate the switch 28 to turn on the warning lamp assembly 10. As the safety helmet 99 is put on the user's head, the user's motorcycle riding condition is reacted to the safety helmet 99 so that the direction and speed sensor 24 senses the variation in the directions of X, Y, Z direction axes and gravitational acceleration, determining whether or not the user changes the steering direction or stops the motorcycle. When the user changes the steering direction, the control circuit 22 controls the warning lamp set 26 to generate a corresponding visual signal. For example, when the user changes the steering direction to the right, the right-sided yellow LED 26Y is driven to flash; when the user stops the motorcycle, the three red LEDs 26R are driven to give off light; when the user turns right and stops the motorcycle, the right-sided yellow LED 26Y is controlled to flash and the three red LEDs 26R are controlled to give off light.

Further, as the safety helmet 99 is exposed to the outside open air when in use, the seamless design of the housing 11 effectively stops outside rainwater from entering the housing 11 to wet the internal circuit during raining, avoiding a short circuit.

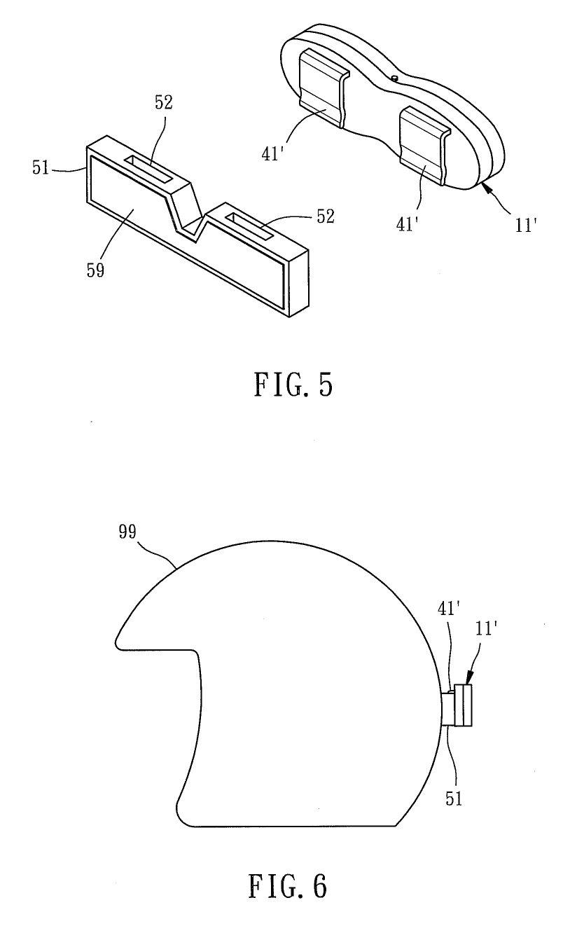

FIGS. 5 and 6 illustrate a warning lamp assembly 50 for safety helmet in accordance with a second embodiment of the present invention. This second embodiment is substantially similar to the aforesaid first embodiment with the exception the exception stated below:

The second embodiment further comprises a connection block 51 adhered to the surface of the rear side of the safety helmet 99 with an adhesive 59. Further, the connection block 51 has two hook holes 52. Further, the use of the adhesive 59 to adhere the connection block 51 to the safety helmet 99 is simply an example but not a limitation. For example, a double-sided adhesive tape may be used to substitute for the adhesive 59.

Further, the mounting device in accordance with this second embodiment consists of two hooks 41′ that extend from the housing 11′ for hooking in the hook holes 52 of the connection block 51 for quick connection between the warning lamp assembly 50 and the safety helmet 99. When dismounting the warning lamp assembly 50 from the safety helmet 99, remove the hooks 41′ from the hook holes 52 of the connection block 51. Thus, the housing 11′ and the connection block 51 are relatively detachable and the connection block 51 is adhered to the rear side of the safety helmet 99, i.e., the housing 11′ is detachably connected to the safety helmet 99.

Subject to the aforesaid arrangement, the housing 11′ of the warning lamp assembly 50 is detachably connectable to the safety helmet 99.

The other structural details and functioning and effects of this second embodiment are same as the aforesaid first embodiment, and therefore no further detailed description in this regard is necessary.

Further, it is to be understood that the structure of the housing consisting of a body shell and a cover shell in the aforesaid first embodiment is simply an example but not a limitation, any other watertight seamless housing design can be used as a substitute; the housing and the other internal components are joined together by insert molding so that all the related components and the housing are formed in integrity during molding of the housing. As the technique of insert molding is the known art, no further detailed description in this regard is necessary.

As stated above, the invention has the advantages: The structure of the present invention is simple when compared to the prior art designs. Further, the installation of the present invention is easy. Further, the warning lamp assembly of the present invention is to be installed in a safety helmet 99 in a detachable manner, enhancing convenience of use.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A warning lamp assembly for use in a safety helmet, comprising:
a housing externally watertight, said housing having at least one part thereof transparent;
a circuit board mounted inside said housing, said circuit board comprising a control circuit, a direction and speed sensor and a warning lamp set respectively electrically connected together;
a battery pack mounted inside said housing and electrically connected to said circuit board to provide battery power to the components at said circuit board; and
a mounting device located on the outside of said housing and detachably connectable to a safety helmet.

2. The warning lamp assembly for safety helmet as claimed in claim 1, wherein said warning lamp set comprises a plurality of light-emitting diodes.

3. The warning lamp assembly for safety helmet as claimed in claim 2, wherein said warning lamp set comprises two yellow light-emitting diodes disposed at opposing left and right sides and three red light-emitting diodes equally spaced between said yellow light-emitting in a transverse row.

4. The warning lamp assembly for safety helmet as claimed in claim 1, wherein said battery pack is selected from the group of dry battery and rechargeable battery.

5. The warning lamp assembly for safety helmet as claimed in claim 1, wherein said mounting device is a vacuum mount comprising a head and a vacuum-forming cup, said head being fixedly connected to said housing.

6. The warning lamp assembly for safety helmet as claimed in claim 1, further comprising a connection block adhered to a rear side of said safety helmet, said connection block having two hook holes, wherein said mounting device comprises two hooks extended from said housing for hooking in said hook holes of said connection block.

7. The warning lamp assembly for safety helmet as claimed in claim 1, further comprising a switch mounted on said housing and electrically connected to said circuit board.

8. The warning lamp assembly for safety helmet as claimed in claim 1, wherein said housing comprises a body shell, and a transparent cover shell covered on said body shell in a watertight manner to prohibit external water from entering said housing.

9. The warning lamp assembly for safety helmet as claimed in claim 8, wherein said body shell and said cover shell are bonded together by high-frequency sealing technology.

10. The warning lamp assembly for safety helmet as claimed in claim 1, wherein said housing and all the components in said housing are bonded together by insert molding.
